(19) United States
(12) Patent Application Publication
(10) Pub. No.: US 2013/0119064 A1
(43) Pub. Date: May 16, 2013

(54) PAINTING APPARATUS

(71) Applicants: Timothy MacKay, Kitchener (CA); Guoli Jian, Waterloo (CA)

(72) Inventors: Timothy MacKay, Kitchener (CA); Guoli Jian, Waterloo (CA)

(73) Assignee: Maxtech Consumer Products Limited, Waterloo (CA)

(21) Appl. No.: 13/466,753

(22) Filed: May 8, 2012

Related U.S. Application Data
(60) Provisional application No. 61/483,835, filed on May 9, 2011.

(51) Int. Cl. B44D 3/12

(52) U.S. Cl. CPC B44D 3/121; B44D 3/126
USPC 220/495.02; 220/736

(57) ABSTRACT

A paint bucket has a preferably removable divider, the divider having a magnet positioned such that at least two paint brushes can be held by it, at least one on each side of the divider. Preferably, at least a portion of the divider is a grid for wiping excess paint off a brush in use. A paint tray has spaced-apart male and female connections, such that when one said liner is inverted over another liner, the liners mate with each other via the male and female connection means, the respective connection means of one liner mating with the opposite connection means of the other liner.

### REFERENCE TO RELATED APPLICATION

This is a formal application based on and claiming the benefit of provisional patent application No. 61/483,835, filed May 9, 2011.

### BACKGROUND OF THE INVENTION

The invention relates to improvements in painting apparatus, and particularly to an improved paint bucket and to paint trays of the type typically used with a paint roller, and to disposable liners for such paint trays.

A common problem when painting is that when “cutting in” paint in a room, i.e. painting walls near ceilings, corners and baseboards or flooring prior to rolling, brushes of various sizes are often used. Typically a smaller container than the paint can, for example a very portable plastic bucket with a handle, is used to carry paint to make it easier to work with, especially going up and down a ladder. Current paint buckets on the market have included a magnet in the bucket and have provided an area where the paint brush could be held by the magnet, since paint brushes commonly have a metal ferrule. However, because the magnet is typically mounted on the outside wall of the bucket, there is only space for one brush to be held.

Another issue in painting, using a paint tray and roller, is that in order reduce the amount of cleanup involved, a plastic tray liner is commonly used. When finished painting, the tray liner is thrown out, creating a significant amount of wasted plastic. Additionally, between each coat the paint remaining in the tray liner dries out, wasting not only the plastic but also a fair amount of paint. Furthermore, consumers (as opposed to builders) often paint rooms within their houses in separate colors, and sometimes these rooms are painted simultaneously. When painting different rooms in different colors a new tray is needed each time, and while one room is being painted in one color, the paint of the other color for the other room dries out. Being able to keep different colors wet and protected between coats can save money, time and effort, and reduce the amount of paint and plastic waste.

### SUMMARY OF THE INVENTION

In the improved paint bucket according to the invention, a vertical divider, which in the preferred embodiment is a paint rolling grid, mounts across part of the paint bucket. A magnet is mounted in the divider, such that paint brushes may be held securely by the magnet on either side of the divider. This allows the user to easily carry two paint brushes, for example a large brush for a majority of the areas and a smaller brush for detail work.

To avoid or minimize the above problems with paint tray liners, male and female elements are molded into the design of the tray liner, such that when a second liner is flipped and reversed, it can mate with the corresponding male and female clips of a first liner, thus preventing air from reaching the paint and drying it out, and acting as a lid so the user doesn't have to throw the first liner away.

### BRIEF DESCRIPTION OF THE DRAWINGS

Embodiments of the invention will now be described, by way of example only, with reference to the attached drawings, in which:

FIG. 1 is a perspective view of an example of a paint bucket according to the invention;

FIG. 2 is an exploded perspective view, showing a disposable plastic liner partially inserted;

FIG. 3 is another exploded perspective view, showing the divider partially installed, and showing the magnet and a cover therefor;

FIG. 4 is a perspective view of an example of a paint tray and liner according to the invention, from the deep end of the tray;

FIG. 5 is a similar perspective view, but from the shallow end of the tray and liner;

FIG. 6 is a perspective view showing a second liner inverted and mated with the first liner—or with the tray if no liner is used; and

FIGS. 7A-7C are perspective views showing a pouring feature of the tray and liner.

### DETAILED DESCRIPTION OF THE INVENTION

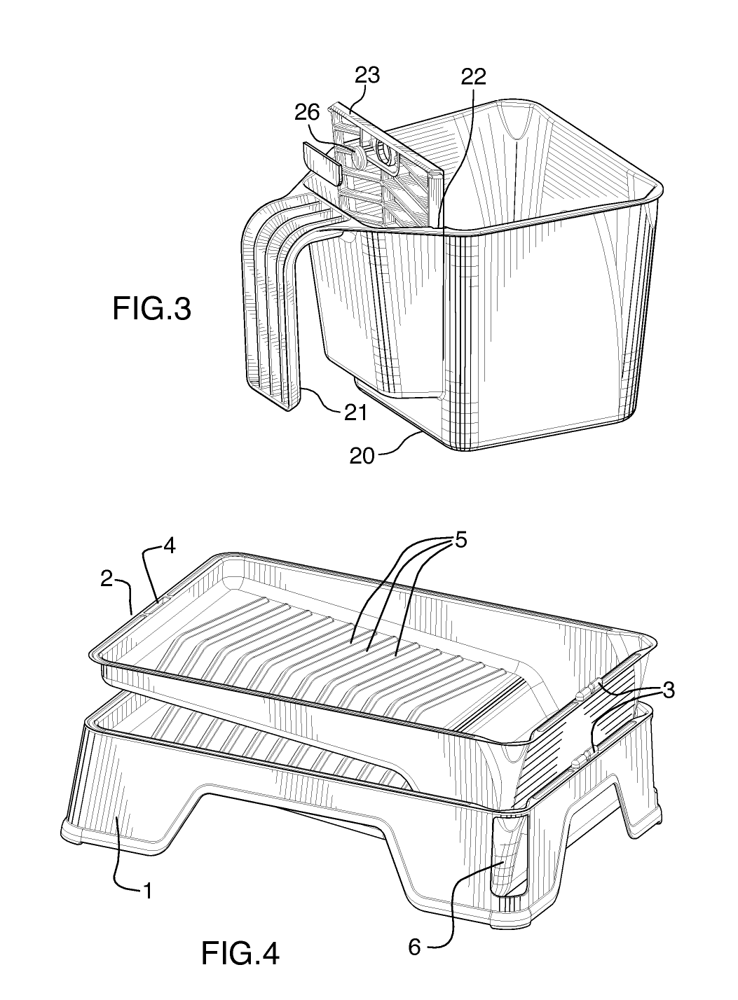

FIGS. 1-3 show an example of a paint bucket 20 according to the invention. The bucket has a handle 21 which makes it easy to carry to the painting location, whether for small touch-up jobs, cutting in, or any other purpose.

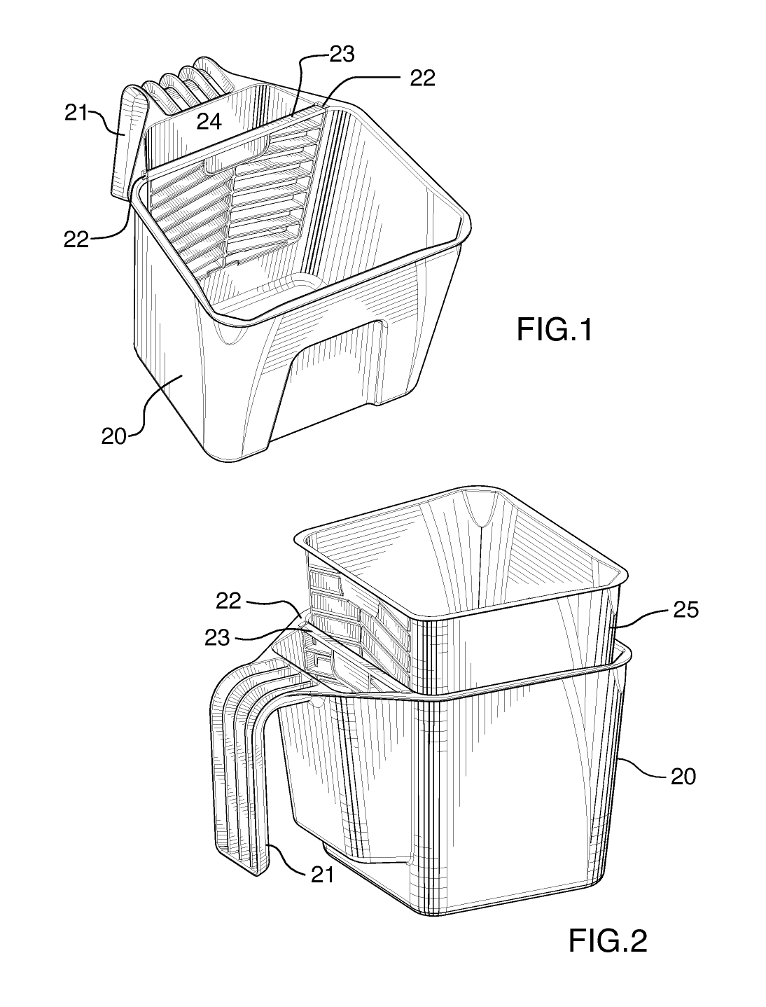

The bucket is configured with opposing vertical slots 22 on opposite sides thereof, in which a divider 23 can be positioned. A sufficiently loose fit is provided that the divider can be installed just in the bucket, or in the bucket with a shape-conforming disposable liner having approximately the same shape as the interior of the bucket. Alternatively, a disposable liner 25 fitting just the “main” portion of the bucket can be provided, as shown in FIG. 2. The divider can extend most of the depth of the bucket, or the full depth of the bucket, but there is no reason why it cannot be shorter, as illustrated. It could even be just a narrow bar.

Preferably, the divider 23 is a grid for use with a small paint roller if desired.

In any event, the key feature of the invention is that the divider has a magnet 26 imbedded therein or otherwise securedly attached at an upper portion 24 of the divider. This permits two brushes to be retained, i.e. one on each side of the divider.

Another advantage of this aspect of the invention is that having the grid or other divider away from the wall of the bucket places the roll-off area and paint drip area away from the edges of the bucket, thus preventing or minimizing paint spillage down the outside of the bucket.

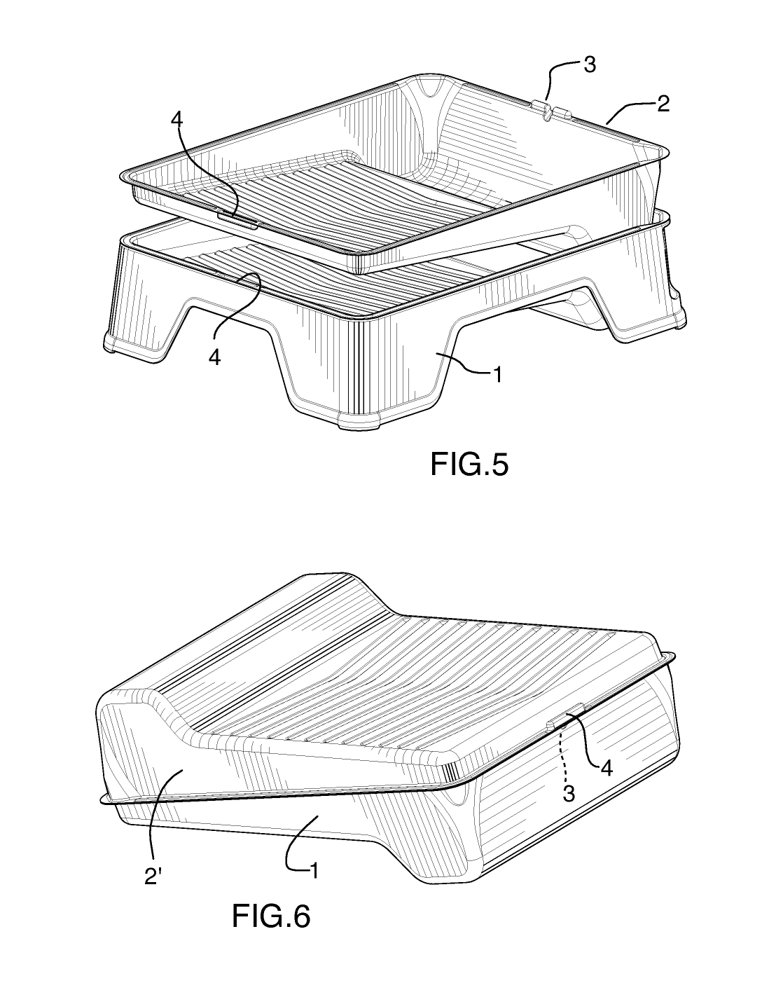

FIGS. 4-7C show an example of an improved paint tray 1 and liner 2 according to the invention. Both the tray and the liner have a raised male portion 3 rising from the center of the tray and liner edges at the deep end of the tray, and a corresponding female depression 4 into the center of the tray and liner edges at the shallow end of the tray.

Of course the male portions could be at the shallow end, and the female portions at the deep end if desired. However, having the female portion at the shallow end reduces the likelihood of interference with the paint roller when the painter is rolling the roller on the ribs 5 as is normally done. If the male portion was at the shallow end, the roller would be more likely to contact it, which could result in paint dripping from the male portion.

As illustrated in FIG. 6, a second tray liner 2′ can be inverted and installed so as to mate with the first tray liner 2—or with the paint tray 1 itself if no first liner was used. The second tray liner thus acts as a cover, to prevent paint in the first liner from drying out quickly.

If desired, the first liner may be removed from the tray, with the second liner still locked in place above it. Of course this may be difficult or impossible if there is a significant volume of paint in the liner, due to its weight and the flexibility of the liners, but typically painters try to judge the amount of paint they need to pour into the tray, and there will not normally be large amounts left. The paired liners may then be stored short term, without the paint drying out. Of course this is not a suitable long term storage solution, but is extremely advantageous for storing the paint for hours, a few days, or perhaps longer.

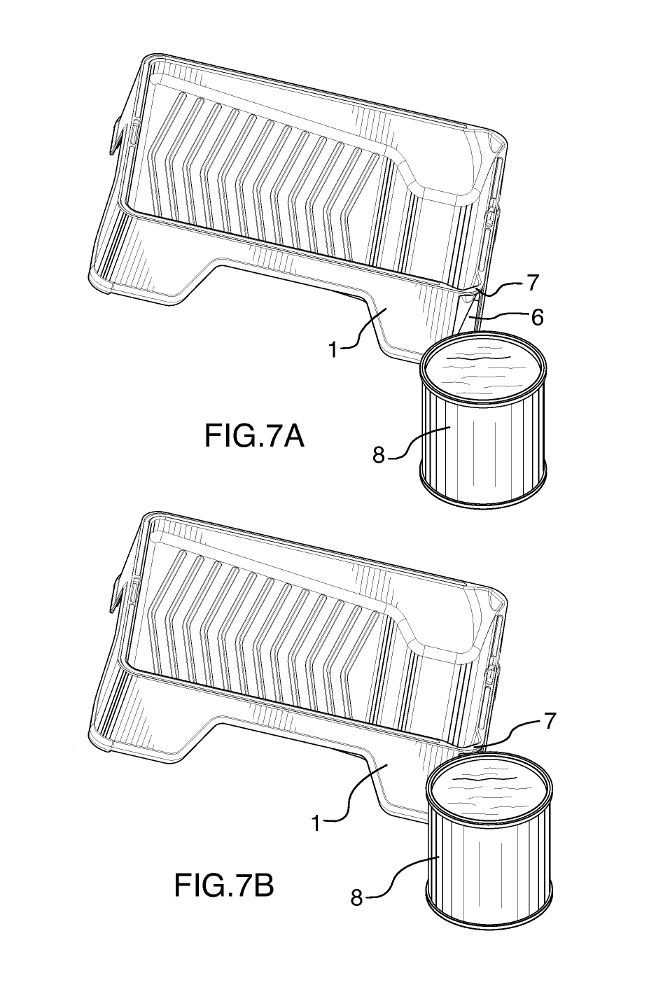

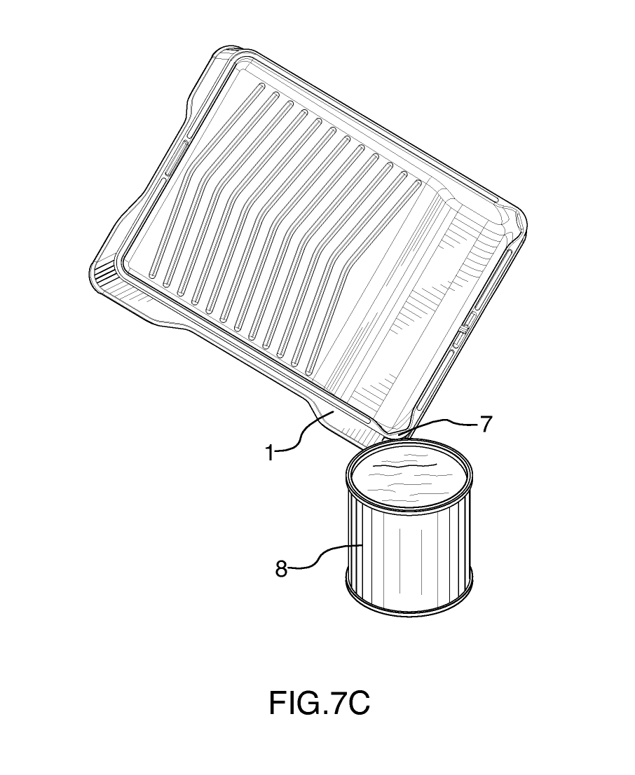

If there is a large amount left, or even a small amount, one option is to pour the remaining paint back into the paint can. Then an optional feature of the invention comes into play, as shown in FIGS. 7A to 7C. As is best seen in FIG. 4, a corner of the paint tray has a cutout area 6. As seen in FIGS. 7A to 7C, this facilitates pouring paint back into the can by allowing the lip 7 of the tray and/or liner to rest securely on the edge of the paint can 8.

Further variations may be apparent or become apparent to those knowledgeable in the field of the invention.

1. A paint bucket, having a divider installable in opposing slots across from each other in opposite sides of the bucket, the divider having a magnet in an upper portion thereof, whereby paint brushes having a metal ferrule may be retained on either side of the divider.

2. A paint bucket as in claim 1, wherein the divider has a grid portion to aid in wiping off excess paint.

3. A liner for a paint tray, the liner having spaced-apart male and female connection means, such that when one said liner is inverted over another said liner, the liners mate with each other via said male and female connection means, the respective connection means of one liner mating with the opposite connection means of the other liner.

4. A liner as in claim 3, wherein the connection means also engage with corresponding means in the paint tray, to aid in aligning and retaining the liner in the paint tray.
